(19) United States
(12) Patent Application Publication
(10) Pub. No.: US 2023/0125930 A1
(43) Pub. Date: Apr. 27, 2023

(54) TECHNIQUES FOR COMBINING GEO-DEPENDENT AND GEO-INDEPENDENT EXPERIENCES IN A VIRTUAL ENVIRONMENT

(71) Applicant: Blizzard Entertainment, Inc., Irvine, CA (US)

(72) Inventors: Cory Stockton, Irvine, CA (US); Chris McCabe, Los Angeles, CA (US); Charlie White, Irvine, CA (US); Russell Bernau, Los Angeles, CA (US); Peter Beissinger, Seattle, WA (US)

(21) Appl. No.: 17/974,175

(22) Filed: Oct. 26, 2022

Related U.S. Application Data
(60) Provisional application No. 63/272,121, filed on Oct. 26, 2021.

(51) Int. Cl. G06F 3/01

(52) U.S. Cl. CPC G06F 3/011; G06F 3/017

(57) ABSTRACT

Techniques for combining geo-dependent and geo-independent experiences in a virtual environment are provided. In one technique, a first geographic location of a first user is received from a first user's device. A second geographic location of a second user is received from a second user's device. Group data that (1) identifies both users as members of a group and (2) identifies an objective to complete in a virtual environment is stored. Completion of the objective requires performance of multiple tasks. Action data that indicates an action, performed while at the first geographic location, that is related to performance of one of the tasks, is received from the first user's device. Similar action data (except with respect to the second geographic and another task) is received from the second user's device. Based on both action data, the group data is updated to indicate that the group completed the objective.

### CROSS REFERENCE TO BENEFIT CLAIM

This application claims the benefit of Provisional Application 63/272,121, filed Oct. 26, 2021, the entire contents of which is hereby incorporated by reference as if fully set forth herein, under 35 U.S.C. § 119(e).

### TECHNICAL FIELD

The technical field relates generally to geographic-based systems and, more specifically, to allowing geographically-dispersed users to participate in completing a common objective in a virtual environment.

### BACKGROUND

Some virtual environment (VE) providers allow users to interact with a VE that is hosted on a computer system that is remote from client devices operated by the users. The digital size of some VEs is small enough to be hosted on a user's client device. When multiple users are interacting with the same VE, then the input from one user must be transmitted to a central computer system/server and then transmitted to the client device of each of the other users so that their respective displays are updated.

Some approaches to VEs do not take into account the geographic locations of the respective users. In such geo-independent VEs, users can virtually gather with each other in the same part of a VE without regards to where they actually reside in the real-world. Unfortunately, because geo-independent VEs are agnostic to the actual geographic locations of the users, real-world movement/travel does not play a role in the gameplay.

Other approaches, geo-dependent VEs take into account the geographic location of users. Specifically, in such geo-dependent VEs, a user's location within the real-world dictates the user's location within the VE. This allows real-world movement/travel to be part of the gameplay, but has the downside that users that are geographically separated have limited ability to interact with each other within the VE.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system architecture for combining geo-dependent and geo-independent experiences in a virtual environment, in an embodiment;

FIG. 2 is a flow diagram that depicts an example process for allowing geographically dispersed group members to accomplish a group objective in a virtual world, in an embodiment;

FIG. 3 is a flow diagram that depicts an example process for a game environment to transition between geographic modes;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

As used herein, a user is in a “geo-dependent” location in a VE when the VE location of the user is dictated, at least in part, on the actual geographic location of the user in the real world. Conversely, a user is in a “geo-independent” location in a VE when the VE location of the user is independent of the action location of the user in the real world.

A system and method for combining geo-dependent and geo-independent experiences in a virtual environment are provided. In one technique, a system allows geographically-dispersed users to work toward a group objective in geo-dependent VE locations that based on their respective real world locations. For example, the system determines a different VE location for each user in a group based on each user's current real-world geographic location. Each user may perform tasks that further the group's goals while at their respective geo-dependent VE locations. The collective actions of all the users in the group work toward satisfying the requirements of the group objective. Upon completion of a group objective, the group may proceed with another objective related to the virtual environment. The completion of the group objective may trigger a change from interacting with the system in a geo-dependent mode to a geo-independent mode. In the geo-independent mode, the tie between the users' actual real-world location and the users' virtual locations is severed, allowing the users to play with and near each other in the virtual environment.

In a related technique, certain triggers cause the system to change user interaction with a virtual environment from a geo-independent mode to a geographic dependent mode and vice versa. The occurrence of a triggering event may affect all users in a group or a strict subset of users in the group.

While embodiments are described in the context of virtual worlds and games, embodiments are not so limited. For example, a virtual environment may simulate a real world place and/or may be for training, team-building, or other non-entertainment purposes.

### System Overview

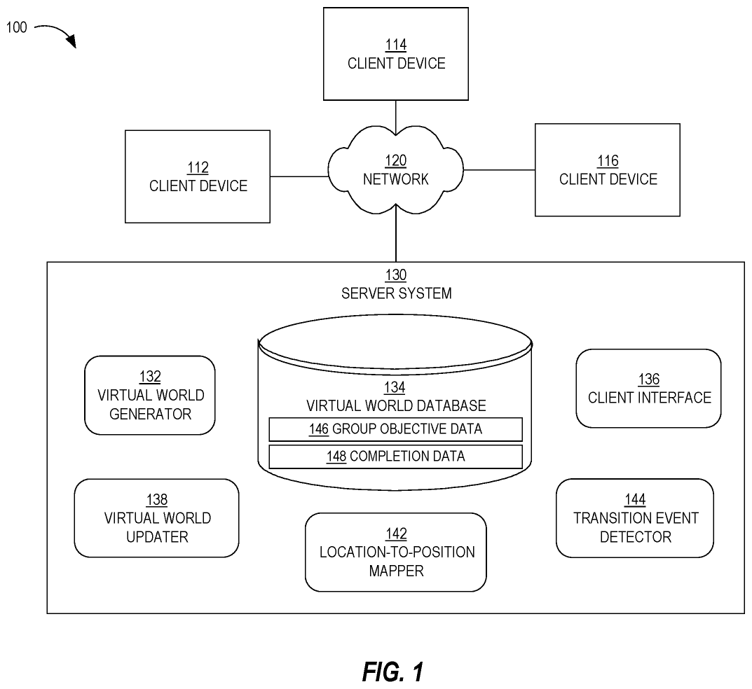

FIG. 1 is a block diagram that depicts an example system architecture 100 for combining geo-dependent and geo-independent experiences in a virtual environment, in an embodiment. System architecture 100 includes client devices 112-116, a network 120, and a server system 130. Network 120 is a computer network, examples of which include a local area network (LAN), a wide area network (WAN), and the Internet.

While only three client devices are depicted in FIG. 1, system architecture 100 may support many client devices that are communicatively coupled to server system 130 over network 120. The client devices may be geographically dispersed across the globe and, thus, may access server system 130 through different networks. Examples of client devices 112-116 include a desktop computer, a laptop computer, a tablet computer, a wearable device, a video game console, and a smartphone.

A client device may receive content from server system 130 in response to transmitting a content request over network 120 to server system 130. Examples of a content request include a new game/virtual experience request or a saved game/virtual experience request. A new game request includes type data that indicates a type of the request, data about the user operating the client device, and, optionally, data about the client device. A request to return to an existing game includes similar data as a new game request, and may also include a game identifier that uniquely identifies an existing game, which may have been paused or may be active while the user of the client device has been offline.

A client application executing on the client device transmits requests to server system 130. Examples of such a client application include (1) a web application that executes within a web browser that executes on the client device and (2) a native application that is installed on the client device and is configured to communicate with server system 130.

A client device may receive content from server system 130 not in response to a request from the client device. For example, server system 130 identifies content that server system 130 determines is relevant to a user of the client device and sends the content to the client device or to an account of the user. The content may be an update to a virtual environment or game with which the user was previously interacting.

### Server System

Server system 130 includes a virtual world generator (VWG) 132, a virtual world database (VWD) 134, a client interface 136, a virtual world updater (VWU) 138, a location-to-position mapper 142, and a transition event detector 144. Although only a single instance of each of these components or elements of server system 130 are depicted in FIG. 1, other embodiments may include more than one of the components or elements, and even more than one server system 130. Each of virtual world generator 132, client interface 136, VWU processor 138, mapper 142, and detector 144 may be implemented in software, hardware, or any combination of hardware and software. Also, VWD 134 may be implemented on one or more non-volatile storage devices.

System architecture 100 may include multiple server systems 130 in order to provide redundant services in case one server system fails or is taken down temporarily. Additionally or alternatively, multiple server systems may be distributed and geographically placed closest to a majority of client devices that access the server systems.

### Virtual World Generator

VWG 132 generates a virtual world for a set of one or more users to participate in virtually from their respective computing devices. As used herein, a “user” refers to a person that operates one of client devices 112-116 to control one or more (virtual) entities or objects in the virtual world, while a “player” (or “user player”) refers to an entity that the user controls and represents the user in the virtual world. A user may control multiple players in a virtual world.

VWG 132 generates a virtual world from a template that is associated with a set of attributes, such as size, dimensions, images, objects within the virtual world, colors, and other attributes. Thus, different virtual worlds may be generated from the same template. VWG 132 may have access to multiple templates. A virtual world (or instance of a virtual world template) has a status, such as active (e.g., users are currently playing in the virtual world), inactive (e.g., no users are currently playing in the virtual world, but some computer-generated activity may be occurring), paused (e.g., no action or activity is occurring in the virtual world), and ended (e.g., no user can participate in the virtual world again).

Each object that exists in a virtual world also has attributes, such as size and dimensions, a location within the virtual world, an image, a sphere of influence, a moveable status (yes or no, or on or off), speed (if moveable), strength (if able to move or fight), life (if able to die or cease to exist), etc. Main types of objects include a (user) player, an obstacle, a computer player, and a computer enemy, which is an object that actively fights and/or defends against a user player. Different objects may have different sets of attributes, not just a different set of attribute values. For example, a first object type has a movement attribute while a second object type does not have a movement attribute because the objects of the second type are stationary.

Data about a virtual world (“virtual world data”) is stored in VWD 134. VWD 134 stores data about one or more virtual worlds that VWG 132 generated. How data about a virtual world and data about objects in the virtual world are stored may vary from one implementation to another. For example, non-object data of a virtual world may be stored in one data structure while virtual world data of objects within a virtual world are stored in another data structure.

Whether a virtual world allows for the participation of a single user or multiple users, virtual world data for a virtual world includes a user identifier for each user. Virtual world data includes attributes of each player corresponding to a user associated with the virtual world, such as an image of the player, position of the player in the virtual world (e.g., x, y, and z coordinates), points earned, life remaining, time spent, time remaining, strength, constitution, and/or accessible tools.

Each user identifier may be associated with a user account that includes information about the corresponding user, such as a name of the user, an IP address of a computing device of the user, user credentials (e.g., username and password), a date when the user subscribed to a service that provides the virtual world experience, a number (and identity) of virtual worlds of which the user's player(s) has/have been a part, statistics of the user's player(s) in those virtual worlds, ratings of the user by other users with whom the user participated in a previous virtual world, comments by the user of the service or of certain virtual worlds, and comments by other users of the user.

Client interface 136 accepts data transmitted from client devices 112-116 and passes the data to VWU 138 if the data pertains to a virtual world. If the data pertains to an active virtual world, then VWU 138 updates a virtual world to which the data pertains. Input from a client device may indicate a movement of an object (e.g., a player) in a virtual world, an action by the object, and/or an action relative to another object (e.g., collecting the other object, striking the other object, throwing the object) in the virtual world. VWU 138 updates attributes of the virtual world based on the input. For example, if the input indicates a player action of picking up a gold coin, then VWU 138 updates virtual world data that indicates that the player has collected a gold coin and that the gold coin is no longer available for others to collect.

VWU 138 may update a virtual world even without input from client devices 112-116. For example, some objects in a virtual world may be computer controlled and, thus, are moving and/or have an effect on other objects in the virtual world.

### Geo-Independent Experiences

In an embodiment, a user of a player in a virtual world experiences the virtual world in a geo-independent mode. In this mode, the geographic location of the user is not taken into account in determining where to position the player in the virtual world. Thus, the user may be on any part on Earth and, as long as the user's computing device is communicatively connected to server system 130 (e.g., through the Internet), the player's position is not affected. For example, the player's position in the virtual world is dictated by user control movements through an interface associated with the player's computing/client device. An example of a such an interface is a game controller with buttons and knobs, the movement of which causes specific action signals to be generated (e.g., a left movement, a kick movement) and transmitted to server system 130. Another example of such an interface is a smartphone through which action instructions (e.g., swipe up finger stroke, a tap of a certain button on the touchscreen) are received and transmitted to server system 130.

Client interface 136 receives these instructions (referred to as “action data”) and VWU 138 updates the corresponding virtual world based on the action data as well as causing the visual presentation of the virtual world to be updated on other client devices whose users are also interacting with the virtual world. For example, if the users of client devices 112-116 are participating in the same virtual world and a user of client device 112 performs one or more actions that causes action data to be transmitted to server system 130, then client interface 136 receives the action data and forwards the action data to client devices 114-116. In this way, instances of the virtual world on client devices 114-116 are similarly updated without having to transmit or refresh the entire virtual world from server system 130.

### Geo-Dependent Experiences

In an embodiment, a user of a player in a virtual world experiences a game involving the virtual world in a geo-dependent mode. In this mode, the geographic location of the user is taken into account in determining how the user interacts with the game. In geo-dependent mode, a virtual map is presented on a computing device of the user. The virtual map depicts real roads/buildings/landmarks, but in a certain art style. Interactive virtual objects (e.g., wolves and berries) are superimposed around the roads/buildings/landmarks.

In a related embodiment. where to position the player in the virtual world. Thus, location-to-position mapper 142 determines a geographic location that is within a certain distance of the current geographic location of the user. The current geographic location of a user may be determined based on GPS (global positioning system) coordinates that are transmitted by the user's client device or based on source information of the client device, such as a source IP address, a source network indicator, or a source cell tower indicator. Source information might not be as precise as GPS information. The current geographic location may define an area in which the user may travel to perform a task that is relevant to the game or to the virtual world. Location-to-position mapper 142 determines candidate locations within the defined area. Candidate locations may be limited to public areas, such as sidewalks, parks, and near known landmarks.

In an embodiment, location-to-position mapper 142 selects a candidate location and maps the selected geographic location to a position in a virtual world in which the player participates. The user travels to the geographic location and the user is prompted to perform one or more actions while at the location. As the user approaches the geographic location, the user's client device transmits its current location to server system 130 and the corresponding player in the virtual world approaches the designated position in the virtual world. Alternatively, the virtual world is updated and the player appears at the designated position in the virtual world only when the user arrives at the geographic location. In this latter scenario, the position of the player in the virtual world does not change while the user is in transit or while the game is in geo-dependent mode. Thus, the player might not be able to perform any actions in the virtual world while in geo-dependent mode until the user arrives at the selected geographic location.

In an embodiment, server system 130 identifies a geographic location and causes a map of the real world to be presented on a user's computing device. The map includes an indicator over the geographic location where a task is to be performed. If the task involves a virtual object (e.g., wolf, tree, coin), then the virtual object may be presented as the indicator. Then, when the user arrives at the geographic location, the map is replaced with a portion of the virtual world and the virtual object appears, allowing the user to virtually interact with the virtual object. In this embodiment, a position in the virtual world is not necessary; instead, traveling to the geographic location to perform a particular task/action.

Example actions that a player performs while the corresponding user is at a selected geographic location include typical player actions, such as a strike, move in a particular direction, jump, and shoot. These actions are dictated by actions that the user performs relative to the user's client device, such as swiping left on a touchscreen or pressing a certain button on the client device or a peripheral that is connected to the client device. Example actions that a user may perform while at a selected geographic location include waving a hand, jumping, making certain facial expressions, and making certain sounds. Such actions may be detected by a camera and/or microphone on the user's client device and translated into corresponding player actions by the client device or by server system 130.

### Groups

As described herein, a virtual world may have multiple player participants, each performing actions in the virtual world and each representing a different user. The users may be geographically dispersed from each other. A set of users may decide to form into a group to perform some mission (also known as quest, raid, task force, expedition, etc.). When users form such a group to perform a mission, the users operate their respective players in the virtual world to accomplish the group objectives associated with the mission. The size of a group may change during a mission involving an instance of a virtual world. For example, a group may have three players at the beginning of a mission, and then later one of the players drops out of the game/group, and then even later two new players join the group.

### Group Objectives

A mission may have one or more objectives, referred to herein as “group objectives.” A group objective comprises one or more tasks. Examples of tasks include users arriving at certain geographic locations within a certain period of time, players (representing the users) collecting a certain number of coins at positions in the virtual world corresponding to the geographic locations, players killing a certain number of spiders at positions in the virtual world corresponding to the geographic locations, and users performing certain types, or a certain combination, of actions at the certain geographic locations.

An aspect or property of a group objective is that any of the users or players in a group can perform the task(s) that are required to complete the group objective. Once the tasks of a group objective are performed, then the group objective is complete and the game progresses. For example, completing a group objective causes a portal within a virtual world to open, where the portal allows all group players to enter in order to advance to the next stage, level, or group objective in the virtual world. Without passing through the portal, no player can progress.

A group objective may require the same task to be performed by every group member. This is referred to as a “uniform objective.” For example, a uniform objective may require that each player kills ten spiders. Thus, the uniform objective cannot be complete until each player performs the task of killing ten spiders. Alternatively, a group objective may require different tasks to be performed by different group members. This is referred to as a “varied objective.” For example, a varied objective may be that player A must kill five spiders and player B must collect eight coins. Thus, the task of different users or players may be of different types (e.g., killing spiders or collecting coins) or, if the same type, the task may be different, such as one player killing ten spiders and another player killing five spiders.

Alternatively, a group objective may require that a certain task be completed but it does not matter which group members perform different parts of the certain task. This is referred to an “unbalanced objective.” For example, an unbalanced objective may require that 20 spiders be killed, but who participates in killing the spiders is not important. Thus, a subset of the group may participate in the objective, but not all are required. One or more group members might not kill any spiders, yet the group objective is complete when the 20 spiders are killed.

In an embodiment, a single virtual world has multiple groups and each group has an objective, which may or may be the same as each other. Also, even if the objective is the same (e.g., kill 20 spiders), the type of objective may vary. For example, one of the group objectives may be a uniform objective while another one of the group objectives may be a varied objective.

Server system 130 stores group objective data 146 and completion data 148 in association with a virtual world. Group objective data 146 and completion data 148 of a particular virtual world may be stored as attributes of the particular virtual world and may be stored with those attributes or separately therefrom.

Group objective data 146 indicates a type of group objective (if multiple objective types are supported or implemented), the specifics of each task of the group objective (e.g., kill 20 spiders and collect 10 coins), and a status of the objective. Completion data 148 indicates progress on each of the one or more tasks of the group objective and, if the group objective depends on the identity of the player (e.g., in a uniform objective or a varied objective), the progress of each player towards a task of the group objective. As a user or player in a group performs a task of the group's objective, server system 130 updates the corresponding completion data 148 of the group objective. Once all the tasks of an objective are performed, a status of the objective changes from “incomplete” to “complete.” An objective's status may have additional values, such as “new” (e.g., before any group member's actions relative to a task have been performed) or “partial” (e.g., indicating that some tasks have been performed or are being performed).

In a related embodiment, completion data 148 is used to generate an image or graphic that is presented to users in a group and that indicates a progress on the group's objective. For example, a colored bar that is 60% full indicates that 60% of the tasks are performed (e.g., 3 out of 5 tasks have been performed) or 60% of the objective is complete (e.g., 12 out of 20 spiders have been killed). Additionally or alternatively, a colored bar may be displayed adjacent to a player indicator where the colored bar indicates how much of that player's tasks have been performed (e.g., in a uniform or varied group objective).

### Performing Objectives While in Geo-Dependent Mode

In an embodiment, some group objectives are performed while the players in the group are in geo-dependent mode. For example, a first group member (whether player or user) must perform a first task while the corresponding user is at or around a first geographic location and a second group member (whether player or user) must perform a second task while the corresponding user is at or around a second geographic location that is different than the first geographic location. Again, the tasks that each group member performs may be the same (e.g., uniform objective) or different (e.g., varied objective).

As a specific example, user A is in California and performs the same types of tasks in his/her area user B performs in New York. Thus, both user A and user B contribute to the same group objective, such as virtually collecting 10 pieces of digital lumber from digital trees: user A might virtually cut down 3 digital trees and user B virtually cuts down 7 digital trees.

Group members may perform their respective tasks at different times. Thus, the first group member may perform the first task before the second group member is even informed of the second task.

Alternatively, a group objective may have a time requirement such that the task(s) of a group objective must be performed at the same time or around the same time, such as within a certain two-hour time period (e.g., between 3 pm-5 pm on October 2) or within two hours of the first group member completing his/her task of the objective.

In an embodiment, a group objective or task within a group objective is related to the types of available physical locations. For example, if an objective is to virtually defeat 10 wolves, then wolves are spawned only at parks, while if an objective is to virtually collect 10 magic berries, then berries are spawned only at shopping centers.

The geographic location in which each group member performs their respective task for a group objective may or may not be mapped to a position in the virtual world. If there is mapping of a user's geographic location to a position in the virtual world, then multiple group members may be mapped the same or different position (or location) in the virtual world. For example, a first geographic location associated with a first user in a group is mapped to a first position in a virtual world and a second geographic location associated with a second user in the group is mapped to a second position in a virtual world. The first position and the second position may be the same position or may be different positions. As a specific example of the same position, a task may be that the two players in a group are to fight the same object in the virtual world, which object exists in only one position in the virtual world, even though the corresponding users were required to travel to different geographic locations in order to perform that task. In this example, the two players might receive damage while performing the task.

### Interact Radius

In an embodiment, a user has an interact radius (e.g., 100 meters) around their physical location. Targets for task completion appear within a user's interact radius. A user's interact radius may be adjusted manually or automatically. A user may interact with any object that is within that user's interact radius. If an object is outside a user's interact radius, then the user is not able to interact with the object, unless the user moves toward the object and the object becomes within the user's interact radius.

A view of an object may change when the object is within a user's interact radius. For example, a user is able to see real world objects (e.g., roads/landmarks) represented on a virtual map of the real world along with virtual objects superimposed on the map. The user may be able to see a player on the map that represents the user. As the user moves, the map may be updated so that the player remains in the middle of the screen. Alternatively, as the user moves, the map is stationary, but the player on the map moves, until the player reaches an edge of the map. Either way, when a virtual interactable object (e.g., an icon representing a monster) appears within a user's interact radius (as a result of automatically spawning in the interact radius or as the result of the user moving toward the object), then the map may be replaced with a different (e.g., full) view/perspective of the object, such as fine details of different parts of the monster. In other words, the display may change from a “map view” (e.g., that shows the player) to an “object-specific view” (e.g., which does not show the map and might not show the player).

In one embodiment, a user does not have to move outside his/her interact radius in order to perform a task. This is referred to as a “limited movement interaction mode.” For example, if a user is near the edge of a park and a group task is to virtually kill 10 wolves, then one or more wolves might spawn within the user's interact radius. After defeating the one or more wolves, the user might have to wait for additional wolves to (automatically) respawn (e.g., in 15 minutes) within the user's current interact radius. In another embodiment, a user must move in order for tasks to appear in the user's interact radius. This is referred to a “mobile interaction mode.” For example, a user defeats wolves within the user's interact radius and then starts walking further into the park where additional wolves will be discovered once the wolves are within the user's interact radius. In this way, the user can defeat all required wolves relatively quickly by exploring the nearby park.

In a related embodiment, different users in a group operate in different interaction modes. In other words, some users in a group operate in limited movement interaction mode while other users in the group operate in mobile interaction mode.

In another related embodiment, a user in a group is able to change his/her interaction mode status. For example, if the user is in limited movement interaction mode and the user desires to move around more or desires to finish his/her task quicker, then the user may select (e.g., via a GUI control) the mobile interaction mode. As another example, changing from limited movement interaction mode to mobile interaction mode may simply involve moving, such as walking, jogging, or running; whereas changing from mobile interaction mode to limited movement interaction mode may simply involve being stationary.

### Transitioning Between Geo-Modes

In an embodiment, interactions with a virtual world (or a game that involves the virtual world) transition from a geo-independent mode to a geo-dependent mode and/or vice versa, in response to certain triggering events. Virtually any type of event may trigger the transition. Examples of events that trigger a geo-dependent to geo-independent transition include, but are not limited to, completion of a group objective, arrival at a certain location within the VE, activation of an object in the VE (e.g., entry of a portal), multiple members of a group concurrently attacking the same type of enemy, etc. Examples of events that may trigger a geo-independent-to geo-dependent transition include completion of a group objective (group defeating a boss), activation of an object in the VE, activation of a user-interface control, defeating a certain type of enemy, etc.

While in geo-dependent mode, a group member may travel to a certain geographic location in order to perform a task of a group objective at the certain geographic location. While in geo-independent mode, the geographic location of the group member has no effect on the virtual world.

In an embodiment, a transition causes a user interface that presents, on a screen of computing device (e.g., client device 112), the virtual world or attributes of the corresponding game to be updated. One or more visual indicators may indicate the geographic mode and/or or a change to the geographic mode. For example, one visual indicator identifies the current mode and, when the mode changes, the visual indicator changes, is updated, or is replaced with a different indicator reflecting the different mode. As another example, a visual indicator may be the removal or addition of a presentation of the virtual world: removal in the case of a transition from geo-independent mode to geo-dependent mode; addition in the case of a transition from geo-dependent mode to geo-independent mode. The presentation of the virtual world may encompass the entirety of a screen of a computing device or may encompass a strict subset (e.g., 10%) of the screen.

In one embodiment, a transition is group-wide, meaning that each group member experiences the transition at the same time, such as when the pre-requisite group objectives have been completed and it is time for the group to battle a boss. In this case, a visual indicator of a transition is presented through a user interface of each group member's client device when the game environment transitions from a geo-independent mode to a geo-dependent mode. In this embodiment, a virtual world that can be associated with different modes has a mode attribute. VWU 138 (or another component of server system 130) updates a value of the mode attribute with a value that indicates which mode the group members are currently in, whether geo-independent or geo-dependent. Based on the update to a mode attribute of a virtual world, VWU 138 causes user interfaces of users in the group of the virtual world to be updated to reflect the update.

In another embodiment, a strict subset of the members in a group experience a transition, such as a transition triggered by two members of a six-member group concurrently fighting the same type of enemy. In this case, the user interface presented on a computing device of a first user (in a group) may be updated to reflect a transition while the user interface presented on a computing device of a second user (in the group) is not updated to reflect any transition, except for possibly an indication that the mode of the first user transitioned. Therefore, some users may be in geo-independent mode while other users may be in geo-dependent mode. The different modes of each user may be reflected in the user interface presented to each user. This may occur if, for example, some group members have completed their respective tasks of a group objective and other group members have not yet completed their respective tasks of the group objective. In this embodiment, each group member in a virtual world is associated with a mode attribute. VWU 138 (or another component of server system 130) updates the mode attribute of each group member that transitions between from one geographic mode to another. Again, based on the update to a mode attribute of a virtual world, VWU 138 causes user interfaces (of at least those group members who transitioned modes) to be updated to reflect the update.

As mentioned above, different events may trigger a transition between the two different geographic-based modes. Example events include two players in the group fighting the same type of enemy, the expiration of a pre-set timer or a timer that was set at the occurrence of a previous event, or the completion of a group objective. For example, a group objective may be that two users in the group arrive at different designated geographic locations. Once they arrive at those respective geographic locations, then the game experience transitions from a geo-dependent mode to a geo-independent mode and the players that correspond to the user are placed at the same position in the virtual world and can proceed from that position, whether it is fighting an enemy at that position, collecting certain objects near that position, or exploring a new location in the virtual world beginning at the position.

As an example of a time-based trigger, if a group objective in a virtual world is not completed by a certain time, then the game experience transitions from a geo-independent mode to a geo-dependent mode where the users in the group must perform more tasks in geo-dependent more in order to progress to the next step or level.

As another example, a transition trigger is the completion of a group objective (e.g., killing ten total spiders) while in geo-dependent mode. Once the group objective is complete, then the game experience transitions to geo-independent mode, at least for those users who were experiencing the game in geo-dependent mode.

In an embodiment, during a transition, a user interface that presents a virtual world is updated to indicate that each player in the group is at the same virtual position. For example, when all users in a group arrive at their respective geographic locations or perform their respective tasks at the respective geographic locations, each user's user interface is updated to show the same position in the virtual world.

When a triggering event occurs, the transition may be immediate, or may require some further action. For example, in one embodiment, when a group objective is completed to trigger transition to geo-independent mode, all members of the group are immediately “teleported” in the virtual world to a geo-independent location within the virtual world (for example, to engage in a group boss battle). In alternative embodiments, the triggering event may cause a portal to appear in the geo-dependent location of each member of the group. Upon entering the portal, the users are virtually “teleported” to a common geo-independent location in the VE. Similarly, upon completion of a boss battle in a geo-independent location in the VE, the member of the group may be immediately “teleported” back to their geo-dependent locations, or may be presented with a portal that takes them to their respective geo-dependent locations.

### Geo-Dependent Group Objective: Process Overview

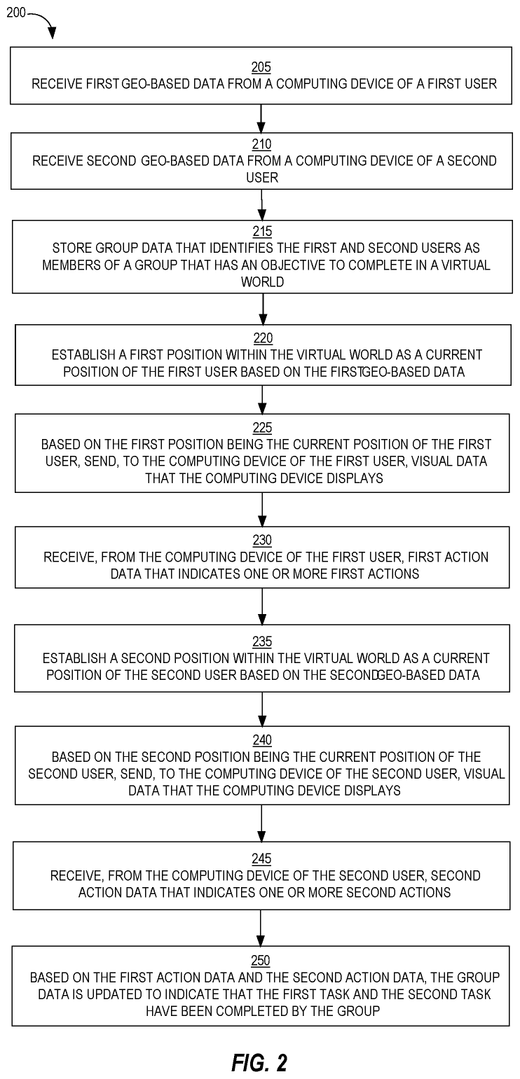

FIG. 2 is a flow diagram that depicts an example process 200 for allowing geographically dispersed group members to accomplish a group objective in a virtual world, in an embodiment. Process 200 may be performed by server system 130.

At block 205, first geo-based data is received from a computing device of a first user. The first geo-based data indicates a first geographic location of the first user. For example, the first geo-based data may indicate that the computing device is located in a particular town in the United States. Server system 130 may continuously receive geo-based data from the computing device of the first user, for example, every five seconds or whenever the application is executing on the computing device.

At block 210, second geo-based data is received from a computing device of a second user that is different than the first user. The second geo-based data indicates a second geographic location of the second user. For example, the second geo-based data may indicate that the computing device of the second user is located in a particular city in Canada.

At block 215, group data is stored that identifies the first user and the second user as members of a group that has an objective to complete in a virtual world. Completion of the objection requires performance of one or more tasks. Block 215 may be performed before 205 and/or 210. The remaining blocks of process 200 are performed while the group data is stored or while the first and second users are members of the same group.

At block 220, a first position within the virtual world is established as a current position of the first user based on the first geo-based data. For example, location-to-position mapper 142 determines that a task for the first user to perform is located at a selected geographic location, which is mapped to a particular position in the virtual world. In order to arrive at the selected geographic location, the first user will need to travel there, whether on foot or via bicycle, car, scooter, or other motorized vehicle.

The first geo-based data may reflect that the first user has or has not arrived at the selected geographic location. If the first user has not arrived at the selected geographic location, then the first position might not be a position within the virtual world in which one of the one or more tasks may be performed. If the first user has arrived at the selected geographic location, then the first position may be a position within the virtual world in which one of the one or more tasks may be performed. Or, only once the first user has arrived at the selected geographic location, the first user is able to cause his/her player to move to a position within the virtual world where one of the task(s) may be performed.

At block 225, based on the first position being the current position of the first user, the computing device of the first user is sent visual data that the computing device displays. The visual data indicates the first position. For example, a visual indication of the first user is presented on a virtual map of the virtual world. As another example, a visual indication of the first user is presented in a digital environment (e.g., a portion of a virtual forest) of the virtual world.

At block 230, first action data that indicates one or more first actions is received from the computing device of the first user. The first actions were executed while a at the first position in the virtual world and perform a first task of the one or more tasks required to complete the objective.

At blocks 235-245 are similar to blocks 220-230 except blocks 235-245 are with respect to the computing device of the second user. Thus, in block 235, based on the second geo-based data, a second position is established the virtual world as a position of the second user. Similarly, in block 245, second action data is received from the computing device of the second user. The second action data indicates one or more second actions that were executed while at the second position in the virtual world and that perform a second task of the one or more tasks required to complete the objective.

At block 250, based on the first action data and the second action data, the group data is updated to indicate that the first task and the second task have been completed by the group. Because the first actions and the second actions may be performed at different times, the group data may be updated at different times.

In a related embodiment, blocks 220, 225, 235, and 240 are not performed. In other words, the real-world location of a user does not cause the player of that user to be mapped to a certain position within the virtual world. For example, the user is supposed to perform a real-world action at the designated geographic location or the player of the user remains at their current position in the virtual world regardless of the user's geographic location. In this latter scenario, the user's arrival at the designated geographic location allows the user's player to perform certain actions while the user's player remains in its current position in the virtual world.

### Transitions Between Geo-Modes: Process Overview

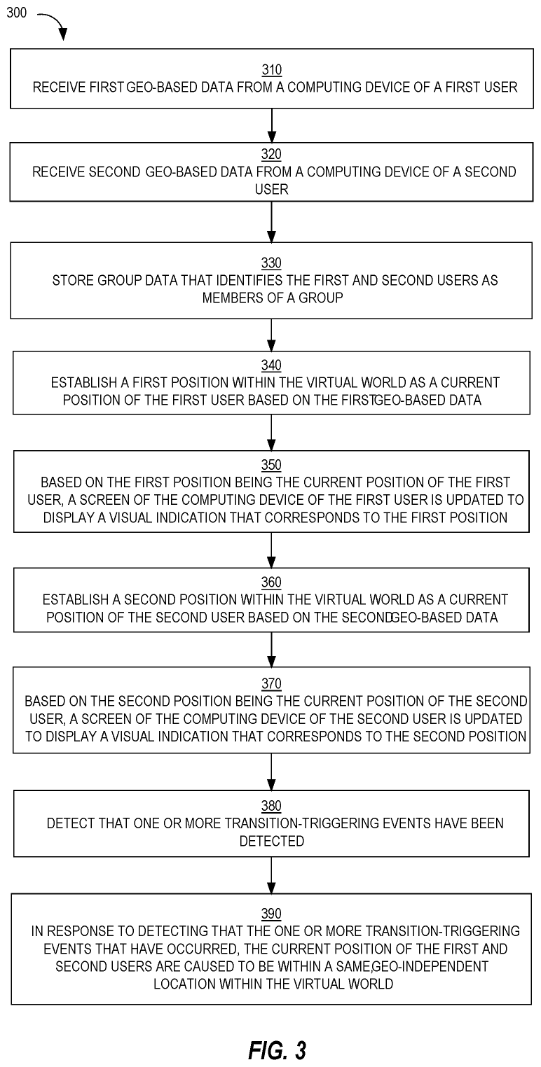

FIG. 3 is a flow diagram that depicts an example process 300 for a game environment to transition between geographic modes, in an embodiment. Process 300 may be performed by server system 130.

At block 310, first geo-based data that indicates a first geographic location of a first user is received from a computing device of the first user. For example, client device 112 transmits GPS data to server system 130 over network 120.

At block 320, second geo-based data that indicates a second geographic location of a second user is received from a computing device of the second user. The second user is different than the first user and the second geographic location is different than the first geographic location.

At block 330, group data that identifies the first user and the second user as members of a group is stored. Group data is associated with (or mapped to) a virtual world that has attributes other than members of the group. The virtual world may have multiple groups interacting with different parts of the virtual world. The remaining blocks of process 300 are performed while the group data is stored or while the first and second users are members of the same group.

At block 340, a first position within the virtual world is established as a current position of the player of the first user based on the first geo-based data. For example, location-to-position mapper 142 receives GPS data transmitted from client device 112 and determines a position in the virtual world based on the GPS data. Alternatively, location-to-position mapper 142 determines a target position to which the player will be transmitted when the first user arrives at a target geographic location.

At block 350, a screen of the computing device of the first user is updated to display a visual indication that corresponds to the first position based on the first position being the current position of the player of the first user. In an alternative embodiment where there is no updating of the position of the player of the first user while in geo-dependent mode, no such visual indication is displayed. Instead, the screen may indicate a map that depicts a current geographic location of the player of the first user and a target geographic location for the first user to travel to.

Blocks 360-370 are similar to blocks 340-350 except with respect to the second user. Thus, at block 360, a second position is established within the virtual world as a current position of the player of the second user based on the second geo-based data. The current position of the player of the second user may be very different than the current position of the player of the first user.

At block 380, one or more transition-triggering events are detected to have occurred. Example transition-triggering events include two players in the group fighting the same object, the lapse of a certain amount of time, or the completion of a group objective.

At block 390, in response to detecting that the one or more transition-triggering events have occurred, the current positions of the players of the first and second users are caused to be within a same, geo-independent position within the virtual world. Block 390 may result in the visual displays (or screens) of the computing devices of the first and second users being updated to depict the players of the respective users or some indication that indicates that both players are in the same position within the virtual world.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

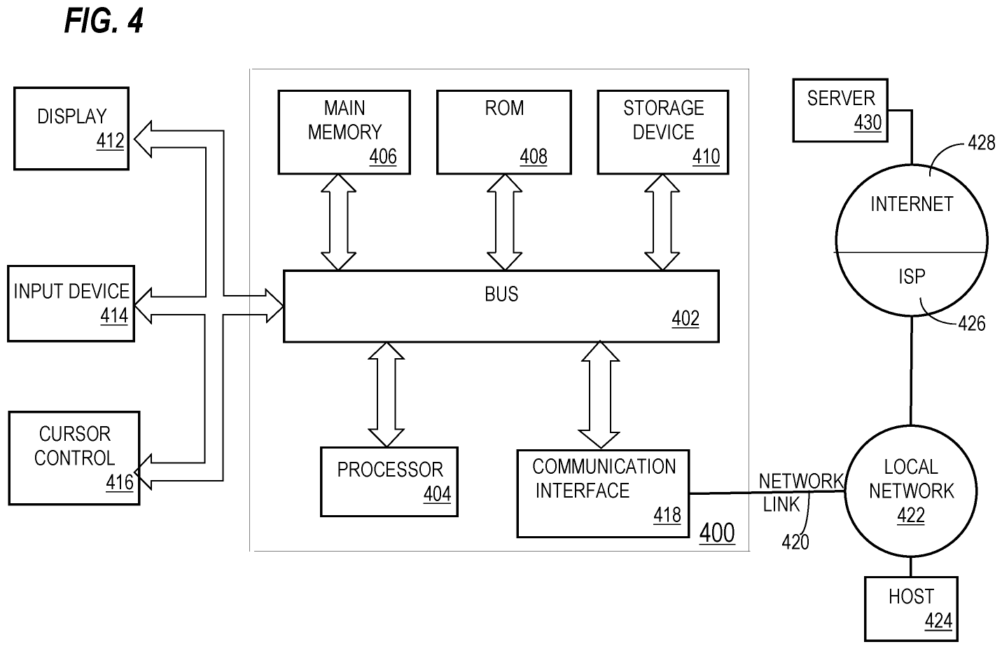

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, from a computing device of a first user, first geo-based data that indicates a first geographic location of the first user;
receiving, from a computing device of a second user that is different than the first user, second geo-based data that indicates a second geographic location of the second user, wherein the second geographic location is different than the first geographic location;
storing group data that (1) identifies the first user and the second user as members of a group and (2) identifies an objective to complete in a virtual environment, wherein completion of the objection requires performance of a plurality of tasks that includes a first task and a second task;
while storing the group data:
receiving, from the computing device of the first user, first action data that indicates one or more first actions, performed while at the first geographic location, that are related to performance of the first task of the plurality of tasks required to complete the objective;
receiving, from the computing device of the second user, second action data that indicates one or more second actions, performed while at the second geographic location, that are related to performance of the second task of the plurality of tasks required to complete the objective;
based on the first action data and the second action data, updating the group data to indicate that the objective has been completed by the group;
wherein the method is performed by one or more computing devices.

2. The method of claim 1, further comprising:
based on the first geo-based data, establishing a first position within the virtual environment as a current position of the first user;
based on the first position being the current position of the first user, causing the computing device of the first user to display a visual indication that corresponds to the first position;
based on the second geo-based data, establishing a second position within the virtual environment as a current position of the second user;
based on the second position being the current position of the second user, causing the computing device of the second user to display a visual indication that corresponds to the second position.

3. The method of claim 1, wherein the first task and the second task are physical tasks to perform at different geographic locations.

4. The method of claim 3, wherein the first task comprises one or more physical gestures or one or more verbal utterances.

5. The method of claim 1, wherein the second task must be performed within a time period that is based on performance of the first task in order to complete the objective.

6. A method comprising:
receiving, from a computing device of a first user, first geo-based data that indicates a first geographic location of the first user;
receiving, from a computing device of a second user that is different than the first user, second geo-based data that indicates a second geographic location of the second user, wherein the second geographic location is different than the first geographic location;
storing group data that identifies the first user and the second user as members of a group;
while storing the group data:
based on the first geo-based data, establishing a first position within a virtual environment as a current position of a player of the first user;
based on the first position being the current position of the player of the first user, causing the computing device of the first user to display a visual indication that corresponds to the first position;
based on the second geo-based data, establishing a second position within the virtual environment as a current position of a player of the second user;
based on the second position being the current position of the player of the second user, causing the computing device of the second user to display a visual indication that corresponds to the second position;
detecting that one or more geo-dependent-to-geo-independent transition-triggering events have occurred in the virtual environment;
in response to detecting that the one or more geo-dependent-to-geo-independent transition-triggering events have occurred, causing a change that enables the player of the first user and the player of the second user to transition to a same, geo-independent position within the virtual environment;
wherein the method is performed by one or more computing devices.

7. The method of claim 6, wherein the change causes the player of the first user and the player of the second user to immediately transition to the geo-independent position.

8. The method of claim 6, wherein the change enables the first player and the second player to perform a particular action that results in immediate transition to the geo-independent position.

9. The method of claim 6, wherein the change is the creation of an object in the virtual environment and the particular action involves activating the object.

10. The method of claim 6, further comprising:
while the current position of the player of the first user and the current position of the player of the second user are within the same geo-independent location within the virtual environment, detecting that one or more geo-independent-to-geo-dependent transition-triggering events have occurred in the virtual environment;
in response to detecting that the one or more geo-independent-to-geo-dependent transition-triggering events have occurred:
changing the current position of the player of the first user in the virtual environment to a position that is based on the first geo-data, and
changing the current position of the player of the second user in the virtual environment to a position that is based on the second geo-data.

11. The method of claim 6, wherein a third user that is different than the first user and the second user is also a member of the group, wherein all members of the group are caused to be within the same, geo-independent position within the virtual environment upon detection of the one or more geo-dependent-to-geo-independent transition-triggering events.

12. The method of claim 6, wherein a third user that is different than the first user and the second user is also a member of the group, wherein a player of the third user is not caused to be within the same, geo-independent position within the virtual environment upon detection of the one or more geo-dependent-to-geo-independent transition-triggering events.

13. The method of claim 12, wherein the one or more geo-dependent-to-geo-independent transition-triggering events comprise two players in the group fighting the same object, the lapse of a certain amount of time, or the completion of a group objective.

14. One or more storage media storing instructions which, when executed by one or more processors, cause:
receiving, from a computing device of a first user, first geo-based data that indicates a first geographic location of the first user;
receiving, from a computing device of a second user that is different than the first user, second geo-based data that indicates a second geographic location of the second user, wherein the second geographic location is different than the first geographic location;
storing group data that identifies the first user and the second user as members of a group;
while storing the group data:
based on the first geo-based data, establishing a first position within a virtual environment as a current position of a player of the first user;
based on the first position being the current position of the player of the first user, causing the computing device of the first user to display a visual indication that corresponds to the first position;
based on the second geo-based data, establishing a second position within the virtual environment as a current position of a player of the second user;
based on the second position being the current position of the player of the second user, causing the computing device of the second user to display a visual indication that corresponds to the second position;
detecting that one or more geo-dependent-to-geo-independent transition-triggering events have occurred in the virtual environment;
in response to detecting that the one or more geo-dependent-to-geo-independent transition-triggering events have occurred, causing a change that enables the player of the first user and the player of the second user to transition to a same, geo-independent position within the virtual environment.

15. The one or more storage media of claim 14, wherein the change causes the player of the first user and the player of the second user to immediately transition to the geo-independent position.

16. The one or more storage media of claim 14, wherein the change enables the first player and the second player to perform a particular action that results in immediate transition to the geo-independent position.

17. The one or more storage media of claim 14, wherein the change is the creation of an object in the virtual environment and the particular action involves activating the object.

18. The one or more storage media of claim 14, wherein the instructions, when executed by one or more processors, further cause:
while the current position of the player of the first user and the current position of the player of the second user are within the same geo-independent location within the virtual environment, detecting that one or more geo-independent-to-geo-dependent transition-triggering events have occurred in the virtual environment;
in response to detecting that the one or more geo-independent-to-geo-dependent transition-triggering events have occurred:
changing the current position of the player of the first user in the virtual environment to a position that is based on the first geo-data, and
changing the current position of the player of the second user in the virtual environment to a position that is based on the second geo-data.

19. The one or more storage media of claim 14, wherein a third user that is different than the first user and the second user is also a member of the group, wherein all members of the group are caused to be within the same, geo-independent position within the virtual environment upon detection of the one or more geo-dependent-to-geo-independent transition-triggering events.

20. The one or more storage media of claim 14, wherein a third user that is different than the first user and the second user is also a member of the group, wherein a player of the third user is not caused to be within the same, geo-independent position within the virtual environment upon detection of the one or more geo-dependent-to-geo-independent transition-triggering events.
